(19) United States
(12) Patent Application Publication
(10) Pub. No.: US 2009/0131114 A1
(43) Pub. Date: May 21, 2009

(54) PORTABLE TELEPHONE TERMINAL

(75) Inventors: Manabu Mukai, Yokohama-shi (JP); Katsuhiko Hayashi, Musashino-shi (JP)

Correspondence Address: Charles N.J. Ruggiero, Esq.;Ohlandt. Greeley, Ruggiero & Perle, L.L.P., One Landmark Square, 10th Floor, Stamford, CT, 06901-2682, US

(73) Assignee: Kabushiki Kaisha Toshiba

(21) Appl. No.: 12/196,442

(22) Filed: Aug. 22, 2008

(30) Foreign Application Priority Data
Aug. 24, 2007 (JP) 2007-218766

(51) Int. Cl. H04B 1/38

(52) U.S. Cl. 455/564

(57) ABSTRACT

A portable telephone terminal includes a browsing unit configured to browse content of a file via a network, a detection unit configured to detect at least one phone number from the content, a selection unit configured to select a phone number from the content by detecting the phone number therefrom, a preparation unit configured to prepare for starting call processing using the phone number selected by the selection unit, the call processing being processing for making a phone call, and a button used to start the call processing.

### CROSS-REFERENCE TO RELATED APPLICATIONS

This application is based upon and claims the benefit of priority from prior Japanese Patent Application No. 2007-218766, filed Aug. 24, 2007, the entire contents of which are incorporated herein by reference.

### BACKGROUND OF THE INVENTION

1. Field of the Invention

The present invention relates to a portable telephone terminal having a phone number input assisting function for calling.

2. Description of the Related Art

Conventional portable telephone terminals are inconvenient in that their telephone function is not linked to information stored in a sentence file or acquired by searching a network, and hence users must, for example, once note down the information.

Telephone systems other than portable telephone terminals employ a technique of storing, in a server, a telephone book database in which names and phone numbers are related to each other, selecting a phone number displayed as a result of searching for a name, and making a call using the selected phone number (see, for example, JP-A 2003-299148 (KOKAI)).

In the telephone systems, the server is required to have a telephone book database and phone number searching function. Namely, each telephone cannot search for a phone number by itself, or directly obtain a phone number from, for example, a text file.

Thus, the conventional portable telephone terminals cannot make a call directly using searched information.

### BRIEF SUMMARY OF THE INVENTION

In accordance with an aspect of the invention, there is provided a portable telephone terminal comprising: a browsing unit configured to browse content of a file via a network; a detection unit configured to detect at least one phone number from the content; a selection unit configured to select a phone number from the content by detecting the phone number therefrom; a preparation unit configured to prepare for starting call processing using the phone number selected by the selection unit, the call processing being processing for making a phone call; and a button used to start the call processing.

According to another aspect of the invention, there is provided a portable telephone terminal comprising: a browsing unit configured to browse files via a network; a detection unit configured to detect at least one phone number from the files while the browsing unit is browsing the files; a selection unit configured to select a phone number from the content by detecting the phone number therefrom; a preparation unit configured to prepare for starting call processing using the phone number selected by the selection unit, the call processing being processing for making a phone call; and a button used to start the call processing.

According to yet another aspect of the invention, there is provided a portable telephone terminal comprising: a browsing unit configured to browse content of a file via a network; a memory unit configured to store the content at least for a preset period; a detection unit configured to detect at least one phone number from the content stored in the memory unit; a selection unit configured to select a phone number from the files by detecting the phone number therefrom; a preparation unit configured to prepare for starting call processing using the phone number selected by the selection unit, the call processing being processing for making a phone call; and a button used to start the call processing.

### BRIEF DESCRIPTION OF THE SEVERAL VIEWS OF THE DRAWING

FIG. 1 is a block diagram illustrating a portable telephone terminal according to the invention;

FIG. 2 is a view illustrating a state in which a call is made using a phone number detected by the portable telephone terminal of FIG. 1;

FIG. 3 is a flowchart illustrating an operation example of a portable telephone terminal according to a first embodiment;

FIG. 4 is a view illustrating an example of data displayed on the display unit that is shown in FIG. 1 and employed in the portable telephone terminal of the first embodiment;

FIG. 5 is a view illustrating an example of data displayed on the display unit that is shown in FIG. 1 and employed in a portable telephone terminal according to a second embodiment;

FIG. 6 is a flowchart illustrating an operation example of the portable telephone terminal of the second embodiment; and

FIG. 7 is a flowchart illustrating an operation example of a portable telephone terminal according to a third embodiment.

### DETAILED DESCRIPTION OF THE INVENTION

Portable telephone terminals according to embodiments of the invention will be described in detail with reference to the accompanying drawings. In the embodiments, like reference numbers denote like elements, and no duplicate explanations will be given.

The portable telephone terminals of the embodiments can perform a phone number input assisting operation in which phone number information from searched information and directly make a call using the extracted phone number information.

### First Embodiment

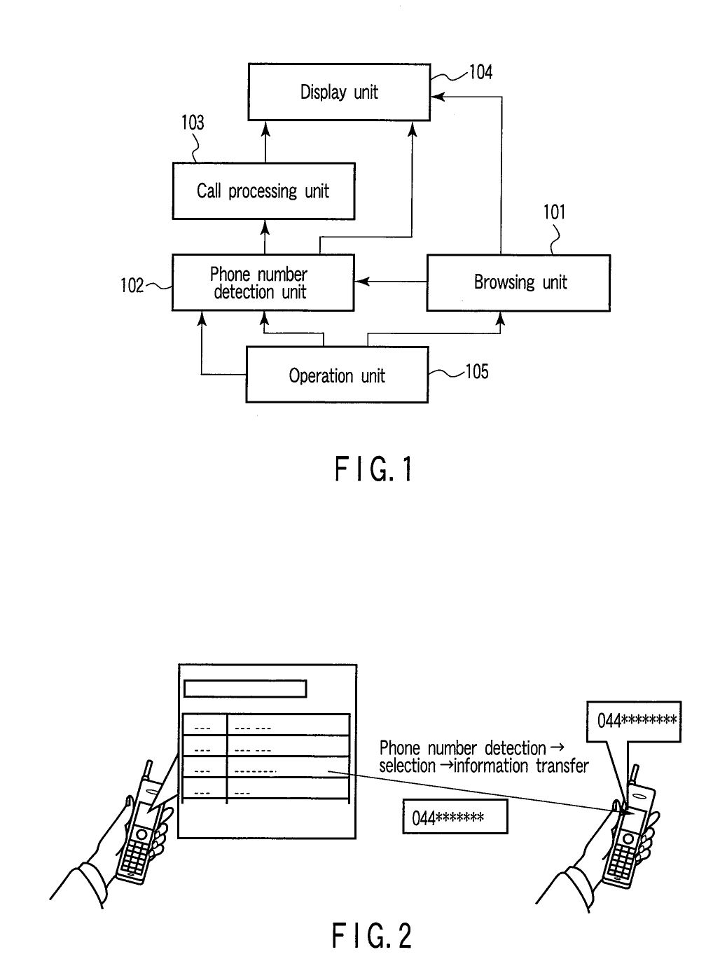

Referring first to FIG. 1, the structure shared between the portable telephone terminals of the embodiments will be described.

As shown, the portable telephone terminals of the embodiments each comprise a browsing unit 101, phone number detection unit 102, call processing unit 103, display unit 104 and operation unit 105. The portable telephone terminals of the embodiments further comprise the elements, such as an antenna, transmitter unit and receiver unit, which are necessarily incorporated in standard portable telephone terminals. These common elements are not essential to the present invention, and therefore will not be described.

The browsing unit 101 browses the content of a file via a network. Further, the browsing unit 101 stores the browsed file content at least for a preset period.

The phone number detection unit 102 executes processing for detecting a phone number in the file currently browsed by the browsing unit 101. Further, the phone number detection unit 102 executes processing for detecting a phone number in the content of a plurality of files browsed during the period elapsing from the activation of the browsing unit 101 and the deactivation of the same. The phone number detection unit 102 may detect a phone number in the content of a file stored in the browsing unit 101. The phone number detection unit 102 transfers the detected phone number to the call processing unit 103.

Furthermore, the phone number detection unit 102 displays the detected phone number on display unit 104. If a user determines that a call may be made using the displayed phone number, the user presses a particular button to instruct the call processing unit 103 to make a call using the phone number.

The call processing unit 103 starts call processing using the phone number acquired from the phone number detection unit 102. The call processing unit 103 may start call processing immediately after acquiring the phone number from the phone number detection unit 102. Alternatively, the call processing unit 103 may start call processing after receiving, from the operation unit 105, an instruction to execute call processing. The call processing unit 103 prepares for starting call processing until receiving, from the operation unit 105, an instruction to start call processing.

The display unit 104 displays the content of the file currently browsed by the browsing unit 101, and the phone number detected by the phone number detection unit 102. Further, the display unit 104 informs start of call processing by the call processing unit 103, by, for example, blinking the phone number with which call processing is started.

The operation unit 105 includes, for example, buttons for operating the portable telephone terminal, which enable a user to operate the browsing unit 101, to start the phone number detection unit 102 to detect a phone number, and to start the call processing unit 103 to execute call processing using the detected phone number.

Referring then to FIG. 2, a description will be given of call processing executed by the portable telephone terminal of the embodiment using the detected phone number.

In a phone number detection method using a conventional portable telephone terminal, a phone number as a search result obtained by a store search through a web is not linked to the call function of the portable telephone terminal, and hence the search result must be once stored. This is inconvenient.

To overcome this problem, in the embodiment, the phone number search engine of the portable telephone terminal is activated during a web search, thereby displaying, on the display unit of the terminal, a phone number detected in a data file (web page) at a website, and transferring the detected phone number information from the data file to the actual call task of the terminal, as is shown in FIG. 2.

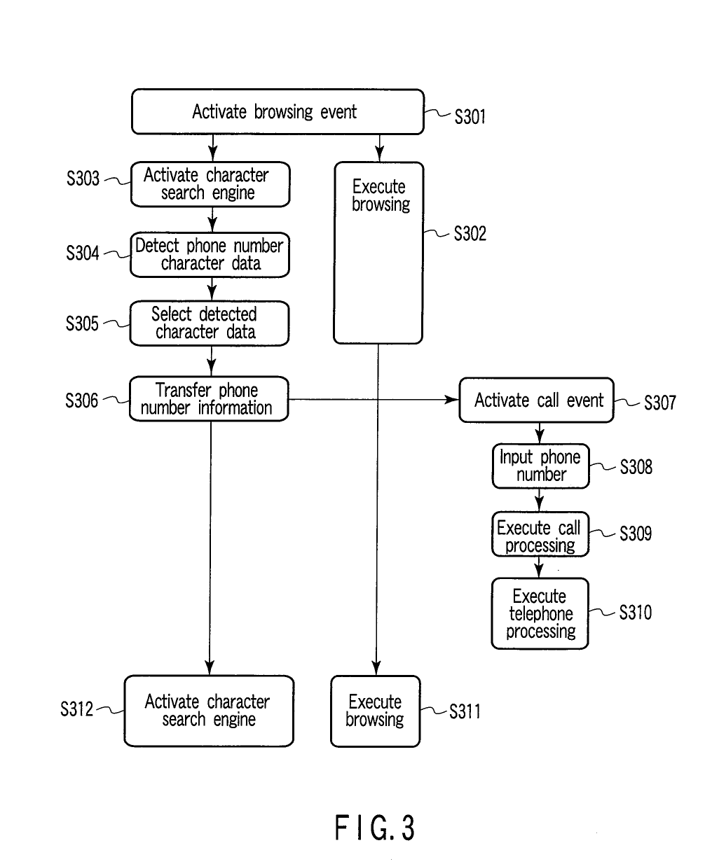

Referring to FIG. 3, a description will be given of an operation example of the portable telephone terminal of the embodiment.

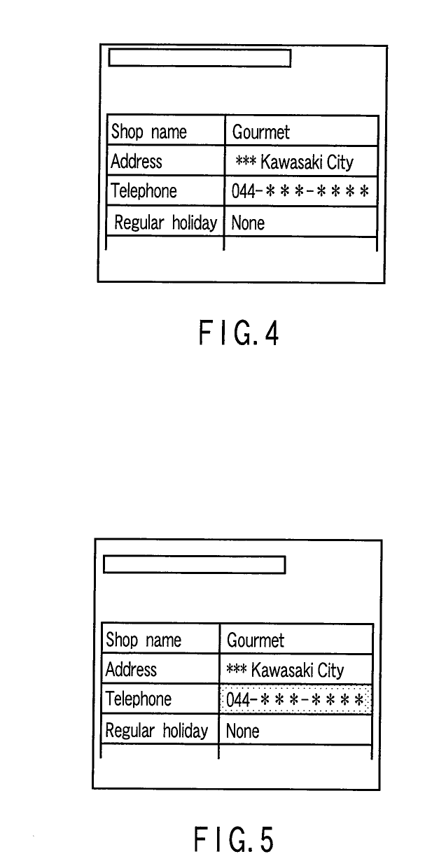

In the portable telephone terminal, the user operates the operation unit 105 to activate the browsing unit 101 so as to start a browsing event (step S301). Upon receiving an instruction from the user, the browsing unit 101 performs processing for accessing a data file or web page (hereinafter referred to as “web information”), such as a text file or HTML file, acquired from a website (step S302). Thus, accessed web information is displayed on the display unit 104. FIG. 4 shows an example of web information displayed on the display unit 104. Immediately after accessing web information at step S302, the phone number detection unit 102 starts to search the accessed web information for a phone number (step S303), and detects it in the web information (step S304). If there is no phone number in the web information, processing of the web information is finished.

If the phone number detection unit 102 detects a phone number at step S304, it transfers the phone number to the display unit 104, where the phone number is displayed. The user determines whether to select the displayed phone number using the operation unit 105. If the displayed phone number is selected (step S305), the phone number detection unit 102 transfers the phone number to the call processing unit 103 (step S306). This function clarifies to which phone number a call should be made, and reduces erroneous input of a phone number.

Upon receiving the phone number, the call processing unit 103 is ready to start call processing using the phone number (activation of a call event at step S307). The call processing unit 103 determines to execute call processing using the phone number received at step S306 (step S308), and starts call processing (step S309). Subsequently, the portable telephone terminal performs standard telephone processing (step S310). Through steps S307 to S310, a call processing image may be displayed on the display unit 104. As the call processing image, the phone number, to which a call is being made, may be displayed. This function better clarifies each phone number to make a call thereto, thereby reducing erroneous input of phone numbers. The above-described operations form one routine for the portable telephone terminal of the first embodiment to detect a phone number and perform call processing using the detected phone number. After that, as shown in, for example, FIG. 3, new web information is accessed (step S311), and searched for a phone number (step S312).

The operation of transferring a phone number to the call processing unit 103, which is performed by the phone number detection unit 102 at step S306, may be changed such that the phone number detection unit 102 transfers a photo number not only to the display unit 104 but also to the call processing unit 103, and the call processing unit 103 activates a call event if the operation unit 105 selects the phone number displayed on the display unit 104 (step S305). Thus, various modifications are possible.

As described above, in the method of the first embodiment, when the portable telephone terminal executes browsing for displaying web information, the phone number detection unit 102 activates its character search engine to acquire phone number information (steps S304 and S305). At this time, as information for a character search to acquire phone number information, the features of character strings generally recognized as phone numbers are used, which include, for example, successive numbers of ten digits, number strings beginning with 0, descriptions such as (***)***-****, (****)**-**** (* denotes a number of 0 to 9), and number strings each following “Tel” or “Telephone,” or in the same row as it. Thus, the phone number detection unit 102 can relatively easily extract phone number information by performing association between phone numbers and character strings. When browsing is currently performed, if call processing is activated by the user, the extracted phone number information is transferred to the call task (steps S307 to S309), standard call mode processing is performed (step S310).

As described above, in the first embodiment, a phone number is searched for and detected in the content of the file currently browsed via a network, and call processing is performed using the detected phone number. Thus, a call can be made without unnecessary processes such as extraction of a phone number from a browsed result displayed, and copying of the phone number, thereby enhancing the convenience of the portable telephone terminal to the user.

### Second Embodiment

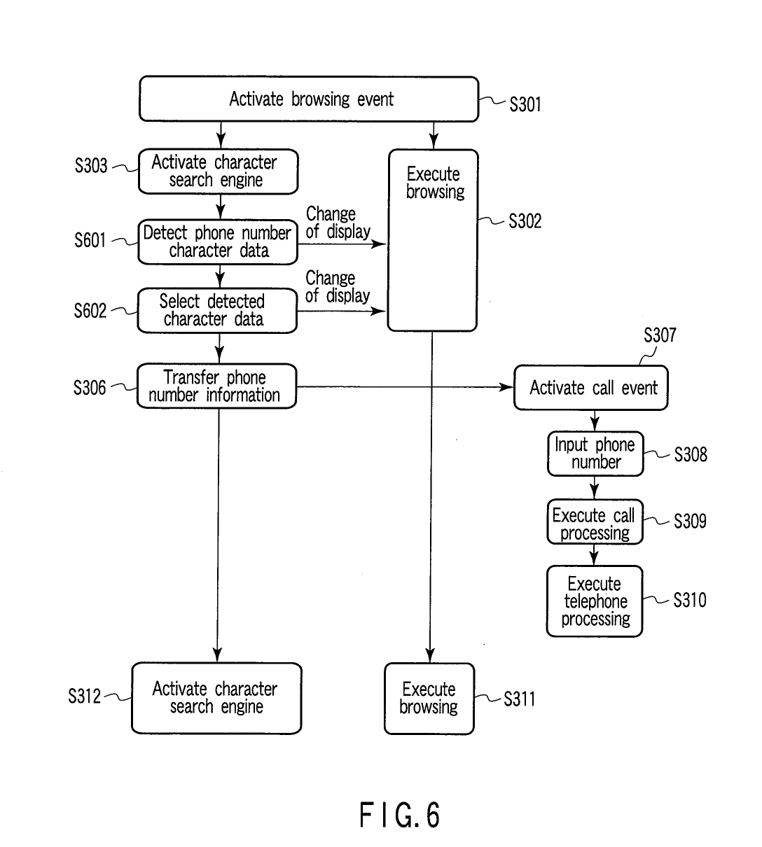

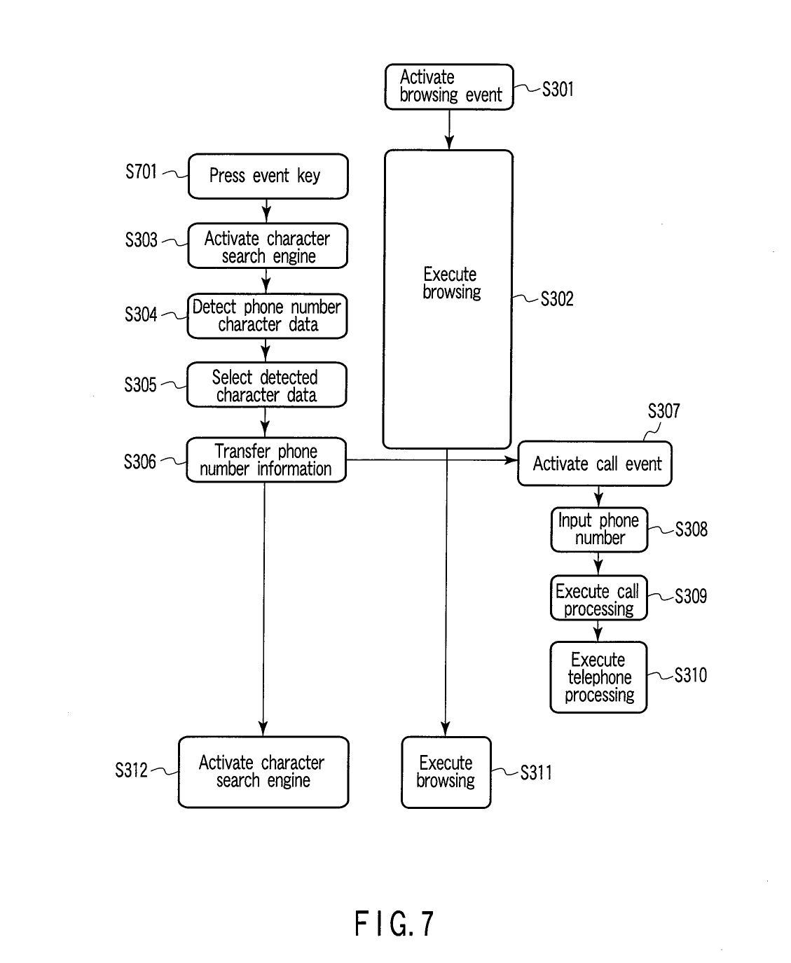

A portable telephone terminal according to a second embodiment differs from the first embodiment in that in the former, the phone number detected at step S304 is displayed in a certain form on the display unit 104, and the form of the displayed phone number is changed at step S305 if the displayed phone number is selected. The display form is, for example, a highlighted display (see FIG. 5), an underlined display, or a blinking display. For instance, a phone number is highlighted at step S304, and if this number is selected, it is underlined at step S305. By virtue of this function, it is clarified which phone number is selected, and hence erroneous input of phone numbers can be reduced. Referring to FIG. 6, a description will be given of an operation example of the portable telephone terminal of the second embodiment. The flowchart of FIG. 6 differs from that of FIG. 3 only in steps S304 and S305.

At step S303, the phone number detection unit 102 starts to search accessed web information for a phone number, detects the phone number in it, and displays the detected phone number in a form different from that of a phone number displayed before the detection (step S601). For instance, the detected phone number is highlighted as shown in FIG. 5. Alternatively, display of the web information displayed at step S302 may be temporarily stopped to display only the detected phone number, or the detected phone number may be displayed at, for example, a corner of the display screen of the display unit 104, with the web information kept displayed.

If the phone number detection unit 102 detects a phone number at step S601, it transfers the phone number to the display unit 104, where it is displayed. The user determines whether to select the displayed phone number using the operation unit 105. If the user selects the phone number displayed on the display unit 104, using the operation unit 105, the display form of the phone number on the display unit 104 is changed from the form employed at step S601 (step S602).

In the method of the second embodiment, the phone number detected by the character search engine of the phone number detection unit 102 is displayed in a form different from a standard form. Thus, the phone number used for call processing is clearly indicated.

In the above-described second embodiment, phone numbers, to which the user of the portable telephone terminal does not intend to make a call, are prevented from being selected, thereby enhancing the convenience of the portable telephone terminal to them.

### Third Embodiment

Also in a portable telephone terminal according to a third embodiment, the browsing unit 101 is activated at step S301 to execute browsing (step S302). However, in the third embodiment, the phone number detection unit 102 does not automatically perform a phone number search, and the user operates, when necessary, the operation unit 105 to cause the phone number detection unit 102 to perform a phone number search. This function differs from the above-described embodiments. Namely, in the third embodiment, only when the user determines that a phone number search is necessary, the user activates the phone number search function. In the case the user tries to activate it, the user executes a particular operation to the operation unit 105. The user activates the phone number search function by, for example, pressing a particular button of the operation unit 105.

In the method of the third embodiment, the portable telephone terminal performs browsing for displaying web information, while the user of the terminal, themselves, activates the character search engine to acquire phone number information.

Thus, in the third embodiment, the load of the browsing task is prevented from being unnecessarily increased, thereby further enhancing the convenience of the portable telephone terminal to the user.

As described above, in the embodiments of the invention, phone number information can be extracted from search information and be directly used to execute call processing.

Although in the embodiments, the portable telephone terminal is mainly assumed to be a cellular phone, it may be another type of electronic device, such as a PC or PDA, which has a function (e.g., Skype) of enabling a phone number to be input to perform communication.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable telephone terminal comprising:
a browsing unit configured to browse content of a file via a network;
a detection unit configured to detect at least one phone number from the content;
a selection unit configured to select a phone number from the content by detecting the phone number therefrom;
a preparation unit configured to prepare for starting call processing using the phone number selected by the selection unit, the call processing being processing for making a phone call; and
a button used to start the call processing.

2. The terminal according to claim 1, wherein the detection unit detects the phone number in association with a character string.

3. The terminal according to claim 1, further comprising a display unit configured to display the content,
wherein:
the display unit displays the phone number, detected by the detection unit, in a second display form different from a first display form in which the phone number fails to be still detected; and
the display unit displays the phone number, selected by the selection unit, in a third display form different from the second display form.

4. The terminal according to claim 3, wherein the display unit displays the phone number selected by the selection unit, when the preparation unit prepares for starting the call processing.

5. The terminal according to claim 1, further comprising an operation unit configured to operate the detection unit, wherein the detection unit starts to detect the phone number when a particular operation is performed on the operation unit.

6. A portable telephone terminal comprising:
a browsing unit configured to browse files via a network;
a detection unit configured to detect at least one phone number from the files while the browsing unit is browsing the files;
a selection unit configured to select a phone number from the files by detecting the phone number therefrom;
a preparation unit configured to prepare for starting call processing using the phone number selected by the selection unit, the call processing being processing for making a phone call; and
a button used to start the call processing.

7. The terminal according to claim 6, wherein the detection unit detects the phone number in association with a character string.

8. The terminal according to claim 6, further comprising a display unit configured to display content of the files,
wherein:
the display unit displays the phone number, detected by the detection unit, in a second display form different from a first display form in which the phone number fails to be still detected; and
the display unit displays the phone number, selected by the selection unit, in a third display form different from the second display form.

9. The terminal according to claim 8, wherein the display unit displays the phone number selected by the selection unit, when the preparation unit prepares for starting the call processing.

10. The terminal according to claim 6, further comprising an operation unit configured to operate the detection unit, wherein the detection unit starts to detect the phone number when a particular operation is performed on the operation unit.

11. A portable telephone terminal comprising:
a browsing unit configured to browse content of a file via a network;
a memory unit configured to store the content at least for a preset period;
a detection unit configured to detect at least one phone number from the content stored in the memory unit;
a selection unit configured to select a phone number from the content by detecting the phone number therefrom;
a preparation unit configured to prepare for starting call processing using the phone number selected by the selection unit, the call processing being processing for making a phone call; and
a button used to start the call processing.

12. The terminal according to claim 11, wherein the detection unit detects the phone number in association with a character string.

13. The terminal according to claim 11, further comprising a display unit configured to display the content,
wherein:
the display unit displays the phone number, detected by the detection unit, in a second display form different from a first display form in which the phone number fails to be still detected; and
the display unit displays the phone number, selected by the selection unit, in a third display form different from the second display form.

14. The terminal according to claim 13, wherein the display unit displays the phone number selected by the selection unit, when the preparation unit prepares for starting the call processing.

15. The terminal according to claim 11, further comprising an operation unit configured to operate the detection unit, wherein the detection unit starts to detect the phone number when a particular operation is performed on the operation unit.
